(19) United States
(12) Patent Application Publication
(10) Pub. No.: US 2014/0120398 A1
(43) Pub. Date: May 1, 2014

(54) Alternate battery power storage compartment

(71) Applicants: Martinus Antonio McCray, Red Springs, NC (US); Owens Daniel McCray, Red Springs, NC (US)

(72) Inventors: Martinus Antonio McCray, Red Springs, NC (US); Owens Daniel McCray, Red Springs, NC (US)

(21) Appl. No.: 13/694,147

(22) Filed: Oct. 31, 2012

(51) Int. Cl. H01M 2/10

(52) U.S. Cl. CPC H01M 2/1083
USPC 429/100

(57) ABSTRACT

A alternate battery power storage compartment for a motorcycle includes a first securing metal bracket adapted to be securely connected to a side of a underbracing pivoting mounted swingarm exterior in front of a motorcycle rear wheel, and a second securing metal bracket adapted to be securely connected to the side of the underbracing pivoting mounted swingarm exterior and being opposite to the first securing metal bracket in front of the motorcycle rear wheel. A u-shaped metal hinge connected to the back view side of the storage compartment centered on a bottom. A top lid securely connected to the storage compartment with a swinging metal hinge.

### CROSS-REFERENCE TO RELATED APPLICATIONS

This application claims the benefit of provisional patent application Ser. No. 61/628,544 Filed 2011 Nov. 1 by the present inventors.

### FEDERALLY SPONSORED RESEARCH OR DEVELOPMENT

“Not Applicable”

### SEQUENCE LISTING, A TABLE, OR A COMPUTER PROGRAM LISTING COMPACT DISC APPENDIX

“Not Applicable”

### BACKGROUND OF THE INVENTION

The present Invention relates to an alternate battery power storage compartment, and more particularly to an alternate battery power storage compartment for a motorcycle. The alternate battery power storage compartment has a four wall box enclosure with a securing top lid and having three back view bracings and a securing support rod.

### SUMMARY

In accordance with one embodiment a battery storage compartment comprising a four wall enclosure having a securing top lid, a metal hinge and securing metal brackets.

### Advantages

Accordingly several advantages of one or more aspects are as follows: to provide additional battery power storage capability, which can be switched to the alternate battery when the engine is not in operation, which can provide power to added accessories without using the main engine starting battery, that is neat and have a custom appearance, that can be easily manufactured with light weight metal, that can be designed with a chrome finish with added color design, more over, the structure of the alternate battery power storage compartment is simple so that no major alterations is required and therefore, the cost is low.

### DRAWINGS

### Figures

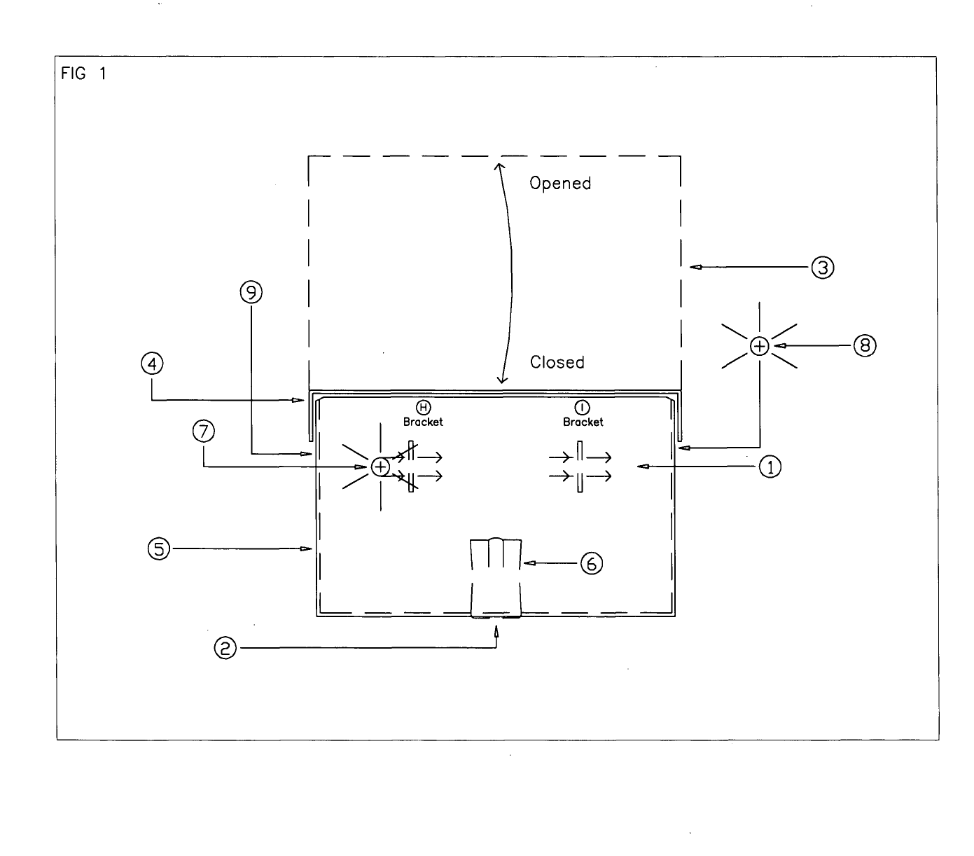

FIG. 1 shows a cut-out view of the battery compartment storage area and top lid open and close position.

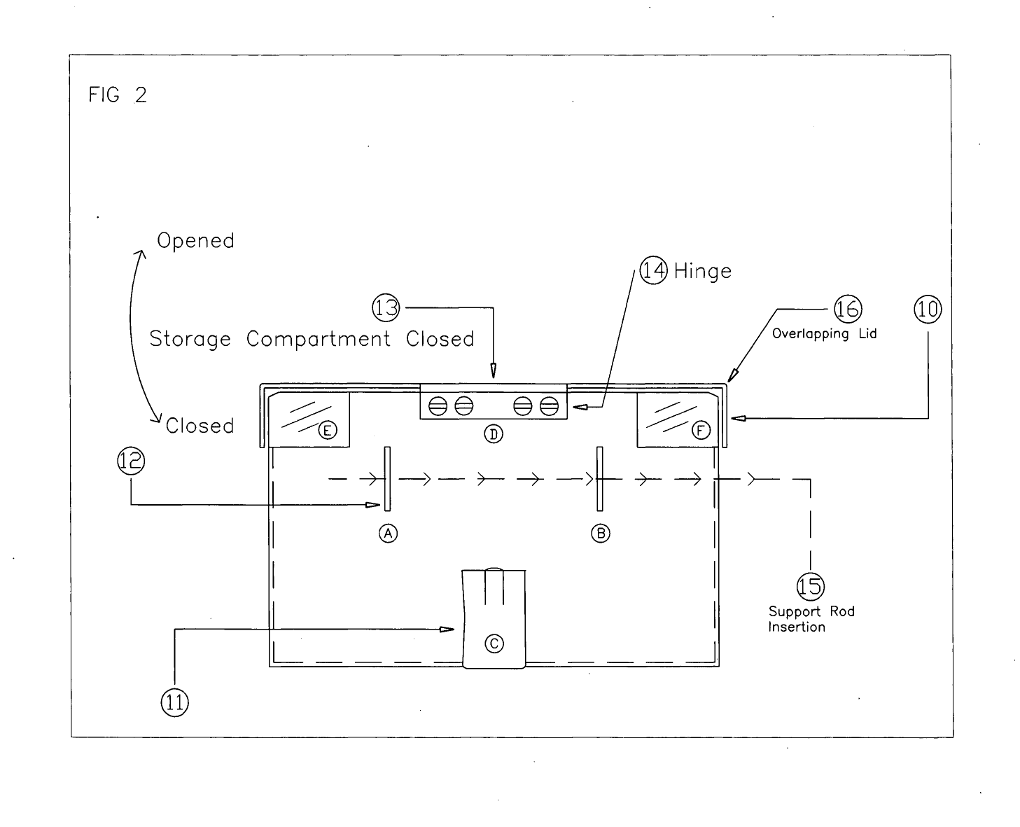

FIG. 2 shows a back view of the storage compartment with item listings.

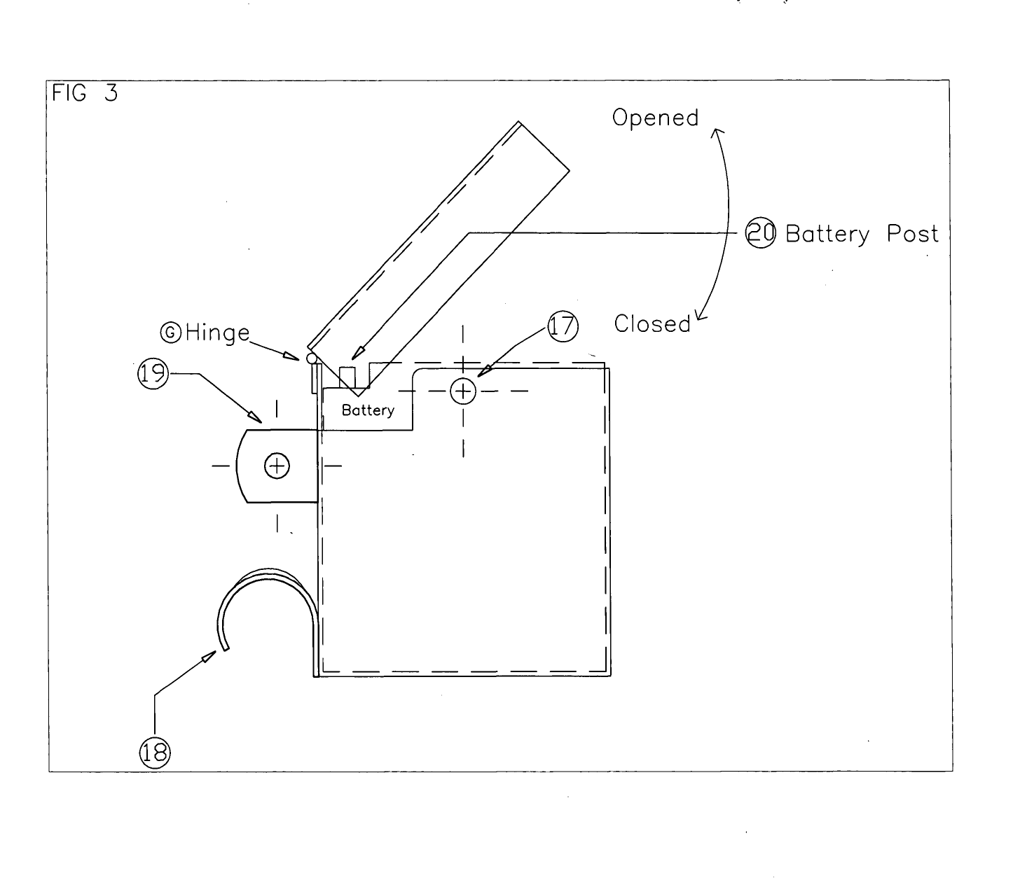

FIG. 3 shows a side cut-out view of the storage compartment with an annotated view of battery post shown inside while the top lid is raised, with additional components shown.

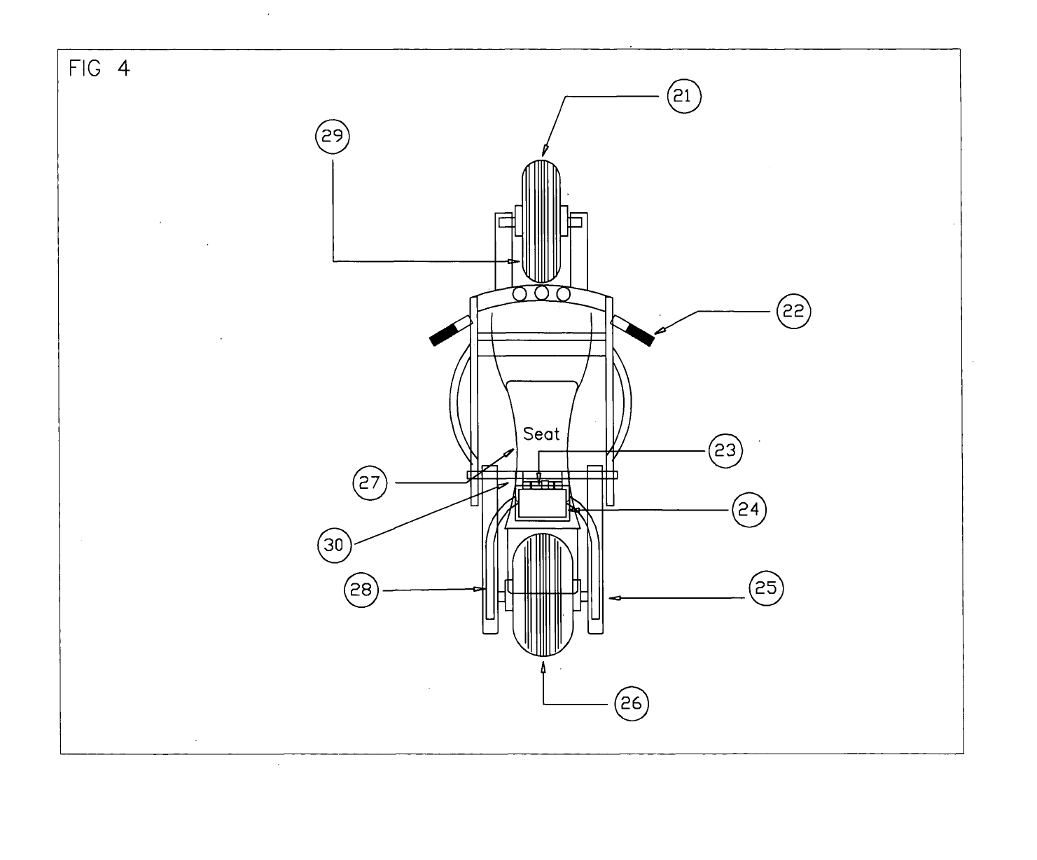

FIG. 4 shows a top view of a motorcycle interior showing the storage compartment placement area.

### ITEM LISTINGS

### Front View

### FIG. NO 1:

1. Metal bracket—dimensions ( 7/16″)

2. Metal hinge—dimensions (1″)

3. Top lid of compartment shown opened.

4. Over hanging flap.

5. Storage compartment (ABP)

6. Raised fabrication—dimensions (1″)

7. Extended view of metal bracket bolt hole.

8. Exterior view of metal bracket bolt hole.

9. View of storage compartment (ABP) showing battery inside of compartment.

### ITEM LISTINGS

### Back View

### FIG. NO 2:

10. Dimensional size of exterior opening—extends from top lid to lower portion of opening—dimensions ( 14/16″)

11. Exterior Hinge—dimensions ( 12/16″)

12. Storage compartment—metal brackets

13. Top lid of storage compartment—closed.

14. Swinging type metal hinge (added)

15. Support rod insertion shown here. This is possible once the compartment is put into place.

16. Overlapping flaps.

### ITEM LISTINGS

### Side View

### FIG. NO 3:

17. Storage compartment—Exterior hole (optional)

18. Exterior hinge—Rotational radius at 110 degrees

19. Metal bracket attached to storage compartment dimensions—( 7/16″)

20. Annotated view of battery post—while top lid is raised.

### ITEM LISTINGS

### Top View

### FIG. NO 4:

### Design: Crude Graphic Design of Motorcycle Exterior.

21. Front wheel.

22. Handle bars.

23. Back view side of ABP shown here placed within the motorcycle interior.

24. Storage compartment interior distance.

25. Exterior of motorcycle swingarm.

26. Motorcycle rear wheel.

27. Annotated view of seat.

28. Exterior swingarm underbracing.

29. Annotated view of front wheel inside the motorcycle interior.

30. Exterior swingarm front underbracing.

### ALPHABETICAL LISTINGS

### FIG. NO 1:

(H-I) Metal brackets

### FIG. NO 2:

(A-B) Metal brackets

(C) Metal hinge

(D) Swinging hinge

(E-F) Storage compartment openings

(G) Swinging hinge that allows the storage compartment to open and close.

### DETAILED DESCRIPTION OF PREFERRED EMBODIMENT

With reference to FIG. 1 (front cut-out view of storage area), the battery compartment (5) has a first securing metal bracket (H), a second securing metal bracket (I), a metal hinge 1″ (2), a top lid compartment shown opened (3), a over hanging flap (4), a extended view of metal bracket bolt hole (7), metal brackets-dimensions 7/16″ (1), raised fabrication-dimensions 1″ (6), and an exterior view of metal bracket bolt hole (8).

With reference to FIG. 2 (back view of storage compartment) (5), and still taking FIG. 1 into consideration, when the battery storage compartment (5) of the present invention is to be assembled, a bottom piece of metal is measured (6¼″, 3¼″) and then cut out to shown figures. Then two side pieces of metal are measured (3¾″) and then cut out to shown figures. The front and back pieces of metal are measured (6¼″, 3¼″), with cut outs on the top left (E), and the top right (F) of the back side piece of the metal measuring (1 5/16″, 14/16″) and then cut to the shown figures. Then all of the measured pieces are assembled by welding them together.

With reference to FIG. 2 (back view of storage compartment), consists of two metal brackets (A, B) with measurements ( 7/16″) that are extended out (1″) with drilled support rod insertion (15) holes in the middle in alignment with each other. The two metal brackets (A, B) are then welded (1″) from the top, and (1½″) from the sides, and (2¼) from the bottom on the back side. A u-shaped metal support hinge (C) measured at (17/16″) at a 110 degree bend, welded to the bottom back side, in the middle of the storage compartment (5) in between the first and second securing metal brackets (A, B).

With reference to FIG. 2 the top lid of the storage compartment (13) is welded to a small swinging hinge (14, D). The storage compartment has four holes drilled for the swinging hinge (14, D) then bolted to the back side of the compartment (5) on the top in the middle; however welding is also optional at this point. This process allows the top lid of the storage compartment (13) to open and close (G) as shown in FIG. 3.

With reference to FIG. 4 the front underbracing of the swingarm (30) is the bracing and securing point for the storage compartment (5). The two vertical bars of the front underbracing (30) are drilled equally aligned for support rod insertion (15). The storage compartment (5) is then placed into the storage compartment allowed area, first by sitting the bottom hinge on the bottom rail of the front underbracing (30) between the two vertical bars of the front underbracing (30), and align the first and second securing metal brackets (A, B) to the drill holes of the vertical bars of the front underbracing (30). The last step is to insert the securing support rod (15) into the aligned through holes of the first and second securing metal brackets (A, B) through the vertical bars. In addition to the last step, refer back to all detailed assembly instructions for proper placement of all parts.

1. A alternate battery power storage compartment for a motorcycle, the alternate battery power storage compartment comprising:
a top lid securely connected to the storage compartment with a swinging metal hinge;
a securing metal bottom of the storage compartment;
a left side metal wall enclosure being opposite of a right side metal wall enclosure;
a front side metal wall enclosure;
a back side metal wall enclosure with a top left corner cut out and a top right corner cut out;
a first securing metal bracket adapted to be securely connected to a side of a underbracing pivoting mounted swingarm exterior in front of a motorcycle rear wheel;
a second securing metal bracket adapted to be securely connected to the side of the underbracing pivoting mounted swingarm exterior and being opposite of the first securing metal bracket in front of the motorcycle rear wheel;
a u-shaped metal hinge connected to the back view side of the storage compartment centered on a bottom;
wherein the first and second securing metal brackets are extended out from the outer back view side; and
wherein each securing metal bracket has a aligned through hole so that a securing support rod is able to extend into the aligned through hole of the front underbracing of the pivoting mounted swingarm.

2. The alternate battery power storage compartment as claimed in claim 1, wherein the top lid securely connected to the storage compartment with a swinging metal hinge that has through holes so that securing bolts is able to extend into the aligned through holes to secure the top lid for opening and closing of the storage compartment.

3. The alternate battery power storage compartment as claimed in claim 1, wherein the back view metal wall enclosure having a top left corner cut out for allowance of a alternate battery cable to extend through to the alternate battery compartment and being opposite a top right corner cut out.
